(19) United States
(12) Patent Application Publication
(10) Pub. No.: US 2016/0365965 A1
(43) Pub. Date: Dec. 15, 2016

(54) WIRELESS APPARATUS

(71) Applicant: FUJITSU LIMITED, Kawasaki-shi (JP)

(72) Inventors: Osamu KURODA, Sendai (JP); Yasuhiro SHIBUYA, Sendai (JP)

(21) Appl. No.: 15/161,030

(22) Filed: May 20, 2016

(30) Foreign Application Priority Data
Jun. 10, 2015 (JP) 2015-117749

(51) Int. Cl. H04L 5/14; H04B 7/04

(52) U.S. Cl. CPC H04L 5/14; H04B 7/04

(57) ABSTRACT

An apparatus includes antenna-systems each configured to include: an antenna, a splitter to split a reflection-signal obtained by reflecting a transmission-signal from the antenna into first and second reflection-signals and output the first reflection-signal to another antenna-system, and a selection section to select the second reflection-signal, the first reflection-signal output by the splitter in the another antenna-system, or a feedback-signal of the transmission-signal and output the selected signal via a common path; a distortion compensator to compensate distortion of the transmission-signal by using the feedback-signal selected by the selection section in the antenna-system; a standing-wave-ratio calculator to calculate a standing-wave-ratio by using the first reflection-signal or the second reflection-signal that is selected by the selection section in the antenna-system; and a controller to control the selection section in the another antenna-system so as to calculate the standing-wave-ratio by using the first reflection-signal output by the splitter in the one antenna-system.

### CROSS-REFERENCE TO RELATED APPLICATION

This application is based upon and claims the benefit of priority of the prior Japanese Patent Application No. 2015-117749, filed on Jun. 10, 2015, the entire contents of which are incorporated herein by reference.

### FIELD

The embodiments discussed herein are related to a wireless apparatus.

### BACKGROUND

Conventionally, some wireless apparatuses such as a base station compensate distortion of a transmission signal. Specifically, such a wireless apparatus transmits a signal and the signal is amplified to produce distortion. The wireless apparatus then feeds back the amplified transmission signal to a distortion compensation circuit to compensate the distortion of the transmission signal.

In recent years, some other wireless apparatuses measure a voltage standing wave ratio (VSWR) as an index for monitoring high-frequency characteristics of an antenna. The voltage standing wave ratio is a voltage ratio of a traveling wave and a reflected wave. Here, the traveling wave is a transmission signal from the wireless apparatus and the reflected wave is a reflection signal obtained by reflecting the transmission signal by the antenna.

Japanese Laid-open Patent Publication No. 2013-110693 and Japanese Laid-open Patent Publication No. 2005-323203 are examples of related art.

In a conventional wireless apparatus separately including a circuit that feeds back a feedback signal of a transmission signal and a circuit that feeds back a reflection signal, the circuit size may increase.

To reduce the circuit size, a structure that partly shares the circuit feeding back the feedback signal of the transmission signal and the circuit feeding back the reflection signal is conceivable. In this structure, the wireless apparatus causes a selection section to select the reflection signal or the feedback signal of the transmission signal to output the selected signal to a distortion compensator or a standing wave ratio calculator via a common path.

However, the structure partly sharing the circuits has difficulty in suppressing degradation of distortion compensation characteristics and maintaining calculation accuracy of the voltage standing wave ratio. Specifically, in the structure partly sharing the circuits, when the selection section selects the feedback signal of the transmission signal and the distortion of the transmission signal is compensated, the reflection signal is not selected and thus the voltage standing wave ratio is not calculated. This degrades the calculation accuracy of the voltage standing wave ratio. On the other hand, when the selection section selects the reflection signal and the voltage standing wave ratio is calculated, the feedback signal of the transmission signal is not selected and thus the distortion is not compensated. This degrades the distortion compensation characteristics.

In view of the above-described circumstances, the disclosed technique aims to provide a wireless apparatus capable of suppressing the degradation of the distortion compensation characteristics and maintaining the calculation accuracy of the voltage standing wave ratio.

### SUMMARY

According to an aspect of the embodiments, a wireless apparatus includes: a plurality of antenna systems each configured to include: an antenna, a splitter configured to split a reflection signal obtained by reflecting a transmission signal from the antenna into a first reflection signal and a second reflection signal and output the first reflection signal to another antenna system, and a selection section configured to select the second reflection signal, the first reflection signal output by the splitter in the another antenna system, or a feedback signal of the transmission signal and output the selected signal via a common path; a distortion compensator configured to compensate distortion of the transmission signal by using the feedback signal selected by the selection section in the antenna system; a standing wave ratio calculator configured to calculate a standing wave ratio by using the first reflection signal or the second reflection signal that is selected by the selection section in the antenna system; and a controller configured to, when the distortion of the transmission signal is compensated by using the feedback signal selected by the selection section in one of the plurality of antenna systems, control the selection section in the another antenna system so as to calculate the standing wave ratio by using the first reflection signal output by the splitter in the one antenna system.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example configuration of a wireless base station apparatus according to embodiment 1;

FIG. 2 is a block diagram illustrating details of an RRH in embodiment 1;

FIG. 3 is a diagram (part 1) illustrating an example of processing operation by the RRH;

FIG. 4 is a diagram (part 2) illustrating an example of the processing operation by the RRH;

FIG. 5 is a flowchart (part 1) illustrating a flow of selection processing of signals in the RRH;

FIG. 6 is a flowchart (part 2) illustrating the flow of the selection processing of signals in the RRH; and

FIG. 7 is a block diagram illustrating details of an RRH in embodiment 2.

### DESCRIPTION OF EMBODIMENTS

Hereinafter, the embodiments of a wireless apparatus disclosed in the present application will be described in detail based on the drawings. The disclosed technique is not limited to the embodiments.

### Embodiment 1

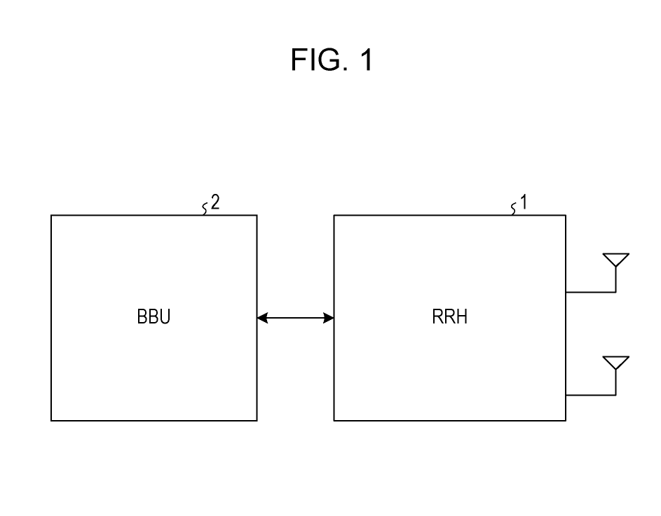

FIG. 1 is an example configuration of a wireless base station apparatus according to embodiment 1. The wireless base station apparatus according to embodiment 1 includes a remote radio head (RRH) 1 and a baseband unit (BBU) 2, as illustrated in FIG. 1.

The BBU 2 is a wireless controller (wireless control device). The BBU 2 controls transmission and reception of signals and performs baseband processing.

The RRH 1 is a wireless section (wireless device). The RRH 1 converts a baseband signal transmitted from the BBU 2 into a radio signal to transmit the converted signal to an external apparatus via an antenna. Additionally, the RRH 1 receives a signal transmitted from the external apparatus through the antenna and converts the received signal into a baseband signal to transmit the converted signal to the BBU 2.

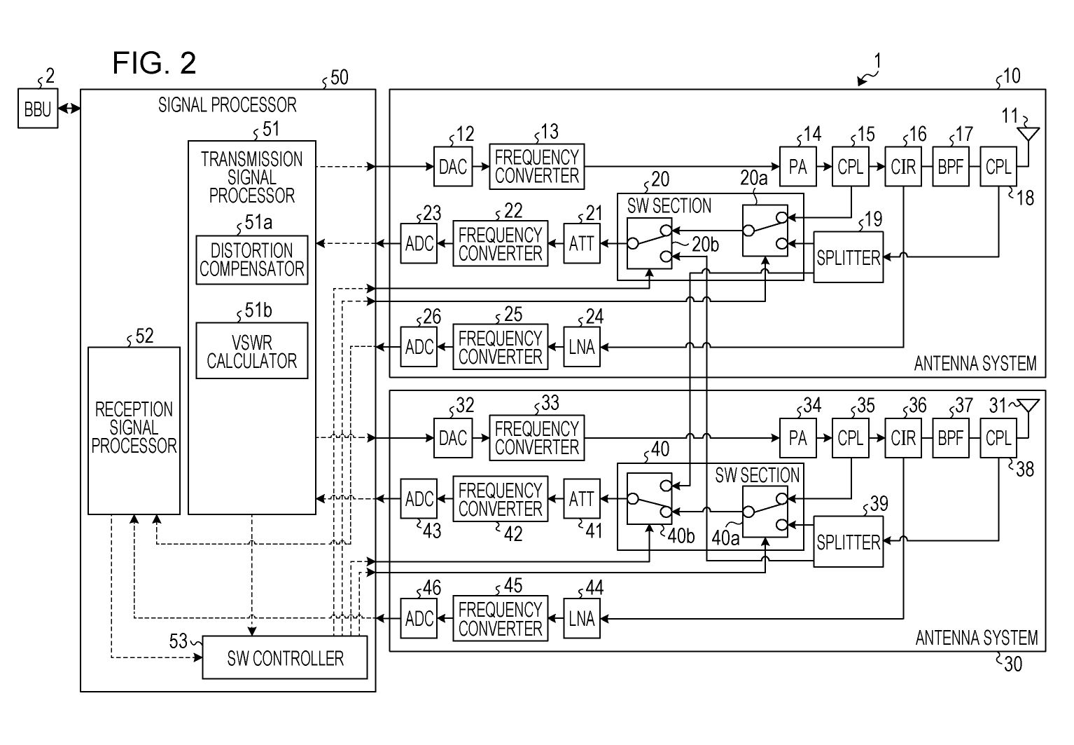

Details of the RRH 1 will now be described with reference to FIG. 2. FIG. 2 is a block diagram illustrating details of the RRH 1 in embodiment 1. The RRH 1, as illustrated in FIG. 2, includes antenna systems 10 and 30 and a signal processor 50. The signal processor 50 includes a transmission signal processor 51, a reception signal processor 52, and a switch (SW) controller 53. To the RRH 1, time-division duplex (TDD) system in which a “transmit interval” and a “receive interval” are temporally divided is applied. Hereinafter, the antenna systems 10 and 30 may be called “a plurality of antenna systems” while each of the antenna systems 10 and 30 may be called “each antenna system”.

The antenna system 10 includes an antenna 11, a digital-to-analog converter (DAC) 12, a frequency converter 13, a power amplifier (PA) 14, a coupler (CPL) 15, a circulator (CIR) 16, a band-pass filter (BPF) 17, a CPL 18, and a splitter 19. The antenna system 10 also includes a SW section 20, an attenuator (ATT) 21, a frequency converter 22, and an analog-to-digital converter (ADC) 23 as well as a low-noise amplifier (LNA) 24, a frequency converter 25, and an ADC 26.

The antenna 11 transmits a signal input from the CPL 18 to the external apparatus while receiving a signal transmitted from an external apparatus to output the signal to the CPL 18.

The DAC 12 receives a transmission signal input from the transmission signal processor 51. The DAC 12 converts the transmission signal that is a digital signal into an analog signal to output the transmission signal converted into the analog signal to the frequency converter 13.

The frequency converter 13 receives the transmission signal input from the DAC 12. The frequency converter 13 then performs frequency conversion on the transmission signal and converts the signal into a radio signal to output the transmission signal converted into the radio signal to the PA 14.

The PA 14 receives the transmission signal that is converted into the radio signal and input from the frequency converter 13. The PA 14 then amplifies the transmission signal to output the amplified transmission signal to the CPL 15.

The CPL 15 receives the transmission signal input from the PA 14. The CPL 15 splits the transmission signal into two transmission signals to output one of the transmission signals to the CIR 16 and the other transmission signal to the SW section 20 as a feedback signal.

The CIR 16 receives the transmission signal input from the CPL 15 and outputs the transmission signal to the BPF 17. The CIR 16 also receives the reception signal input from the antenna 11 via the CPL 18 and the BPF 17 to output the reception signal to the LNA 24.

The BPF 17 receives the transmission signal input from the CIR 16. The BPF 17 allows only a transmission signal in a predetermined frequency band to pass and outputs the passed transmission signal to the CPL 18. The BPF 17 also receives the reception signal input from the antenna 11. The BPF 17 allows only a reception signal in a predetermined frequency band to pass and outputs the passed reception signal to the CIR 16.

The CPL 18 receives the transmission signal input from the BPF 17 and transmits the transmission signal to the external apparatus via the antenna 11. The CPL 18 also receives a reflection signal that is obtained by reflecting the transmission signal by the antenna 11 and input from the antenna 11. The CPL 18 then outputs the reflection signal to the splitter 19. The CPL 18 also receives via the antenna 11 the signal transmitted from the external apparatus to output the reception signal to the BPF 17.

The splitter 19 receives the reflection signal input from the CPL 18. The splitter 19 splits the reflection signal into a first reflection signal and a second reflection signal to output the first reflection signal to the antenna system 30 that is the other antenna system and the second reflection signal to the SW section 20. The splitter 19 is an example of a splitting section.

The SW section 20 selects the second reflection signal, a first reflection signal output from a splitter 39, which will be described later, in the antenna system 30, or the feedback signal of the transmission signal to output the selected signal via a common path. Specifically, the SW section 20 includes a SW 20a and a SW 20b.

The SW 20a receives the feedback signal input from the CPL 15 and receives the second reflection signal input from the splitter 19. The SW 20a selects the feedback signal or the second reflection signal and outputs the selected one of the feedback signal and the second reflection signal to the SW 20b.

The SW 20b receives the feedback signal or the second reflection signal that is input from the SW 20a and receives, as an input from the splitter 39 in the antenna system 30, the first reflection signal that is output by the splitter 39 in the antenna system 30. The SW 20b selects the second reflection signal, the first reflection signal output by the splitter 39 in the antenna system 30, or the feedback signal to output the selected signal to the ATT 21. The signal output from the SW 20b to the ATT 21 is then output from the antenna system 10 via the ATT 21, the frequency converter 22, and the ADC 23 to be input to the transmission signal processor 51 in the signal processor 50.

The SW section 20 thus uses the SW 20a and the SW 20b to select the second reflection signal, the first reflection signal output by the splitter 39 in the antenna system 30, or the feedback signal of the transmission signal. The SW section 20 then outputs the selected signal to the transmission signal processor 51 in the signal processor 50 via the ATT 21, the frequency converter 22, and the ADC 23 that serve as the common path. Using the ATT 21, the frequency converter 22, and the ADC 23 as the common path consequently reduces the circuit size of the antenna system 10.

The selection of signals in the SW section 20 is controlled by the later-described SW controller 53. The SW section 20 is an example of a selection section.

The ATT 21 receives the second reflection signal, the first reflection signal output by the splitter 39 in the antenna system 30, or the feedback signal of the transmission signal that is selected and input by the SW section 20. The ATT 21 then attenuates the electrical power of the second reflection signal, the first reflection signal output by the splitter 39 in the antenna system 30, or the feedback signal of the transmission signal to output the attenuated signal to the frequency converter 22.

The frequency converter 22 receives the second reflection signal, the first reflection signal output by the splitter 39 in the antenna system 30, or the feedback signal of the transmission signal that is input from the ATT 21. The frequency converter 22 then performs frequency conversion on the second reflection signal, the first reflection signal output by the splitter 39 in the antenna system 30, or the feedback signal of the transmission signal and converts the signal into a baseband signal to output the signal converted into the baseband signal to the ADC 23.

The ADC 23 receives the second reflection signal, the first reflection signal output by the splitter 39 in the antenna system 30, or the feedback signal of the transmission signal that is input from the frequency converter 22. The ADC 23 then converts the second reflection signal, the first reflection signal output by the splitter 39 in the antenna system 30, or the feedback signal of the transmission signal into a digital signal to output the signal converted into the digital signal to the transmission signal processor 51 in the signal processor 50.

The LNA 24 receives the reception signal input from the CIR 16. The LNA 24 amplifies the reception signal to output the amplified reception signal to the frequency converter 25.

The frequency converter 25 receives the reception signal input from the LNA 24. The frequency converter 25 then performs frequency conversion on the reception signal and converts the signal into a baseband signal to output the reception signal converted into the baseband signal to the ADC 26.

The ADC 26 receives the reception signal input form the frequency converter 25. The ADC 26 then converts the reception signal into a digital signal to output the reception signal converted into the digital signal to the reception signal processor 52 in the signal processor 50.

The antenna system 30 includes an antenna 31, a DAC 32, a frequency converter 33, a PA 34, a CPL 35, a CIR 36, a BPF 37, a CPL 38, and the splitter 39. The antenna system 30 also includes a SW section 40, an ATT 41, a frequency converter 42, and an ADC 43 as well as an LNA 44, a frequency converter 45, and an ADC 46.

The antenna 31 transmits a signal input from the CPL 38 to an external apparatus while receiving a signal transmitted from the external apparatus to output the signal to the CPL 38.

The DAC 32 receives a transmission signal input from the transmission signal processor 51. The DAC 32 converts the transmission signal that is a digital signal into an analog signal to output the transmission signal converted into the analog signal to the frequency converter 33.

The frequency converter 33 receives the transmission signal input from the DAC 32. The frequency converter 33 then performs frequency conversion on the transmission signal and converts the signal into a radio signal to output the transmission signal converted into the radio signal to the PA 34.

The PA 34 receives the transmission signal that is converted into the radio signal and input from the frequency converter 33. The PA 34 then amplifies the transmission signal to output the amplified transmission signal to the CPL 35.

The CPL 35 receives the transmission signal input from the PA 34. The CPL 35 splits the transmission signal into two transmission signals to output one of the transmission signals to the CIR 36 and the other transmission signal to the SW section 40 as a feedback signal.

The CIR 36 receives the transmission signal input from the CPL 35 and outputs the transmission signal to the BPF 37. The CIR 36 also receives the reception signal input from the antenna 31 via the CPL 38 and the BPF 37 to output the reception signal to the LNA 44.

The BPF 37 receives the transmission signal input from the CIR 36. The BPF 37 allows only a transmission signal in a predetermined frequency band to pass and outputs the passed transmission signal to the CPL 38. The BPF 37 also receives the reception signal input from the antenna 31. The BPF 37 allows only a reception signal in a predetermined frequency band to pass and outputs the passed reception signal to the CIR 36.

The CPL 38 receives the transmission signal input from the BPF 37 and transmits the transmission signal to the external apparatus via the antenna 31. The CPL 38 also receives a reflection signal that is obtained by reflecting the transmission signal by the antenna 31 and input from the antenna 31. The CPL 38 then outputs the reflected signal to the splitter 39. The CPL 38 also receives via the antenna 31 the signal transmitted from the external apparatus to output the reception signal to the BPF 37.

The splitter 39 receives the reflection signal input from the CPL 38. The splitter 39 splits the reflection signal into the first reflection signal and a second reflection signal to output the first reflection signal to the antenna system 10 that is the other antenna system and the second reflection signal to the SW section 40. The splitter 39 is an example of the splitting section.

The SW section 40 selects the second reflection signal, the first reflection signal output from the splitter 19 in the antenna system 10, or the feedback signal of the transmission signal to output the selected signal via a common path. Specifically, the SW section 40 includes a SW 40a and a SW 40b.

The SW 40a receives the feedback signal input from the CPL 35 and receives the second reflection signal input from the splitter 39. The SW 40a selects the feedback signal or the second reflection signal and outputs the selected one of the feedback signal and the second reflection signal to the SW 40b.

The SW 40b receives the feedback signal or the second reflection signal that is input from the SW 40a and receives, as an input from the splitter 19 in the antenna system 10, the first reflection signal that is output by the splitter 19 in the antenna system 10. The SW 40b selects the second reflection signal, the first reflection signal output by the splitter 19 in the antenna system 10, or the feedback signal to output the selected signal to the ATT 41. The signal output from the SW 40b to the ATT 41 is then output from the antenna system 30 via the ATT 41, the frequency converter 42, and the ADC 43 to be input to the transmission signal processor 51 in the signal processor 50.

The SW section 40 thus uses the SW 40a and the SW 40b to select the second reflection signal, the first reflection signal output by the splitter 19 in the antenna system 10, or the feedback signal of the transmission signal. The SW section 40 then outputs the selected signal to the transmission signal processor 51 in the signal processor 50 via the ATT 41, the frequency converter 42, and the ADC 43 that serve as the common path. Using the ATT 41, the frequency converter 42, and the ADC 43 as the common path consequently reduces the circuit size of the antenna system 30.

The selection of signals in the SW section 40 is controlled by the later-described SW controller 53.

The ATT 41 receives the second reflection signal, the first reflection signal output by the splitter 19 in the antenna system 10, or the feedback signal of the transmission signal that is selected and input by the SW section 40. The ATT 41 then attenuates the electrical power of the second reflection signal, the first reflection signal output by the splitter 19 in the antenna system 10, or the feedback signal of the transmission signal to output the attenuated signal to the frequency converter 42.

The frequency converter 42 receives the second reflection signal, the first reflection signal output by the splitter 19 in the antenna system 10, or the feedback signal of the transmission signal that is input from the ATT 41. The frequency converter 42 then performs frequency conversion on the second reflection signal, the first reflection signal output by the splitter 19 in the antenna system 10, or the feedback signal of the transmission signal and converts the signal into a baseband signal to output the signal converted into the baseband signal to the ADC 43.

The ADC 43 receives the second reflection signal, the first reflection signal output by the splitter 19 in the antenna system 10, or the feedback signal of the transmission signal that is input from the frequency converter 42. The ADC 43 then converts the second reflection signal, the first reflection signal output by the splitter 19 in the antenna system 10, or the feedback signal of the transmission signal into a digital signal to output the signal converted into the digital signal to the transmission signal processor 51 in the signal processor 50.

The LNA 44 receives the reception signal input from the CIR 36. The LNA 44 amplifies the reception signal to output the amplified reception signal to the frequency converter 45.

The frequency converter 45 receives the reception signal input from the LNA 44. The frequency converter 45 then performs frequency conversion on the reception signal and converts the signal into a baseband signal to output the reception signal converted into the baseband signal to the ADC 46.

The ADC 46 receives the reception signal input form the frequency converter 45. The ADC 46 then converts the reception signal into a digital signal to output the reception signal converted into the digital signal to the reception signal processor 52 in the signal processor 50.

The transmission signal processor 51 includes a distortion compensator 51a and a voltage standing wave ratio (VSWR) calculator 51b. The distortion compensator 51a is a circuit that performs distortion compensation based on the digital pre-distortion (DPD) system. The distortion compensator 51a uses the feedback signal selected by the SW section in each antenna system (the SW section 20 or the SW section 40) and compensates the distortion of the relevant transmission signal. Specifically, the distortion compensator 51a receives the transmission signal of the baseband signal input from the BBU 2. The distortion compensator 51a also receives the feedback signal that is selected by the SW section in each antenna system (the SW section 20 or the SW section 40) and input from the ADC in each antenna system (the ADC 23 or the ADC 43). The distortion compensator 51a compares the feedback signal with the relevant transmission signal to obtain a difference. The distortion compensator 51a calculates a distortion compensation coefficient for making the obtained difference closer to 0 and uses the calculated distortion compensation coefficient to compensate the distortion of the relevant transmission signal. The distortion compensator 51a then outputs the transmission signal subjected to the distortion compensation to the DAC in each antenna system (the DAC 12 or the DAC 32). Additionally, the distortion compensator 51a outputs to the SW controller 53 information indicating the difference used for calculation of the distortion compensation coefficient, between the feedback signal and the relevant transmission signal.

The VSWR calculator 51b uses the first reflection signal or the second reflection signal that is selected by the SW section in each antenna system (the SW section 20 or the SW section 40) to calculate a VSWR of the relevant antenna (the antenna 11 or the antenna 31). Specifically, the VSWR calculator 51b receives the transmission signal of the baseband signal input from the BBU 2. The VSWR calculator 51b also receives the first reflection signal or the second reflection signal that is selected by the SW section in each antenna system (the SW section 20 or the SW section 40) and input from the ADC in each antenna system (the ADC 23 or the ADC 43). The VSWR calculator 51b calculates the VSWR that is a voltage ratio of the first reflection signal or the second reflection signal to the transmission signal. The VSWR is an example of a standing wave ratio. The VSWR calculator 51b is an example of a standing wave ratio calculator.

The transmission signal processor 51 controls the timing for transmit intervals of the time-division duplex system. The transmission signal processor 51 outputs information indicating start timing and end timing of the transmit intervals to the SW controller 53.

The transmission signal processor 51 determines, depending on the amount of data of the transmission signal input from the BBU 2, whether any one of the antenna systems 10 and 30 or both are used to transmit the signal in the transmit interval of the time-division duplex system. The transmission signal processor 51 then outputs the information indicating the determined transmission manner to the SW controller 53.

The reception signal processor 52 controls the timing for receive intervals of the time-division duplex system. The reception signal processor 52 outputs information indicating start timing and end timing of the receive intervals to the SW controller 53.

The reception signal processor 52 receives the reception signal input from the ADC in each antenna system (the ADC 26 or the ADC 46), in the receive interval of the time-division duplex system. The reception signal processor 52 performs predetermined reception processing on the reception signal to transmit the reception signal subjected to the reception processing to the BBU 2.

The SW controller 53 controls the SW section in each antenna system (the SW section 20 or the SW section 40). Specifically, the SW controller 53 performs the following processing when the distortion of the transmission signal is compensated by using the feedback signal selected by the SW section in one of the antenna systems 10 and 30. The SW controller 53 controls the SW section in the other antenna system in order to calculate the VSWR using the first reflection signal output by the splitter in one of the antenna systems.

The control by the SW controller 53 will now be described in further detail. A case is taken as an example where the SW section 20 in the antenna system 10 selects the feedback signal and the distortion compensator 51a compensates the distortion of the transmission signal using the feedback signal relevant to the antenna system 10. In this case, to calculate the VSWR using the first reflection signal output by the splitter 19 in the antenna system 10, the SW controller 53 controls the SW section 40 in the antenna system 30 that is the other antenna system. Specifically, the SW controller 53 sends to the SW 40b in the SW section 40 a selection command instructing to select the first reflection signal output by the splitter 19 in the antenna system 10. The SW 40b in the SW section 40 receives the selection command to select the first reflection signal output by the splitter 19 in the antenna system 10, and then outputs the selected first reflection signal to the VSWR calculator 51b in the transmission signal processor 51 via the common path. This allows the VSWR calculator 51b to calculate the VSWR by using the first reflection signal relevant to the antenna system 10, when the distortion compensator 51a compensates the distortion of the transmission signal using the feedback signal relevant to the antenna system 10.

Another case is taken as an example where the SW section 40 in the antenna system 30 selects the feedback signal and the distortion compensator 51a compensates the distortion of the transmission signal using the feedback signal relevant to the antenna system 30. In this case, to calculate the VSWR using the first reflection signal output by the splitter 39 in the antenna system 30, the SW controller 53 controls the SW section 20 in the antenna system 10 that is the other antenna system. Specifically, the SW controller 53 sends to the SW 20b in the SW section 20 a selection command instructing to select the first reflection signal output by the splitter 39 in the antenna system 30. The SW 20b in the SW section 20 receives the selection command to select the first reflection signal output by the splitter 39 in the antenna system 30, and then outputs the selected first reflection signal to the VSWR calculator 51b in the transmission signal processor 51 via the common path. This allows the VSWR calculator 51b to calculate the VSWR by using the first reflection signal relevant to the antenna system 30, when the distortion compensator 51a compensates the distortion of the transmission signal using the feedback signal relevant to the antenna system 30.

Additionally, when the distortion of the transmission signal is compensated by using the feedback signal selected by the SW section in one of the antenna systems 10 and 30, in the transmit interval of the time-division duplex system, the SW controller 53 controls the SW section in the other antenna system.

The SW controller 53 receives from the distortion compensator 51a information indicating the difference used for calculation of the distortion compensation coefficient, between the feedback signal and the relevant transmission signal (hereinafter, simply referred to as “difference”). At this time, when the distortion of the transmission signal is compensated and the difference is greater than a predetermined threshold, the SW controller 53 controls the SW section in the other antenna system. When the difference is greater than the predetermined threshold, relatively long time is taken to calculate the distortion compensation coefficient for making the difference closer to 0, which may leave insufficient time to calculate the VSWR in the transmit interval of the time-division duplex system. The SW controller 53 thus controls the SW section in the other antenna system to enable calculation of the VSWR relevant to the one antenna system in the case where the distortion of the transmission signal relevant to the one antenna system is compensated and the difference is greater than the predetermined threshold.

Conversely, when the distortion of the transmission signal is compensated and the difference is equal to or less than the predetermined threshold, the SW controller 53 stops control of the SW section in the other antenna system and performs the following processing after the distortion compensation of the transmission signal is finished. The SW controller 53 controls the SW section in the one antenna system in order to calculate the VSWR using the second reflection signal output by the splitter in one of the antenna systems. A case is taken as an example where the distortion relevant to the antenna system 10 is compensated and the difference is equal to or less than the predetermined threshold. In this case, relatively short time is taken to calculate the distortion compensation coefficient for making the difference closer to 0, which may highly possibly leave time to calculate the VSWR in the transmit interval of the time-division duplex system. The SW controller 53 thus controls the SW section 20 in the antenna system 10 so as to calculate the VSWR using the second reflection signal output by the splitter 19 in the antenna system 10. Specifically, the SW controller 53 sends to the SW 20a and the SW 20b in the SW section 20 a selection command instructing to select the second reflection signal output by the splitter 19 in the antenna system 10. The SW 20a and the SW 20b in the SW section 20 receive the selection command to select the second reflection signal output by the splitter 19 in the antenna system 10, and then output the selected second reflection signal to the VSWR calculator 51b in the transmission signal processor 51 via the common path. This achieves both the distortion compensation of the transmission signal and the calculation of the VSWR by using only the antenna system 10.

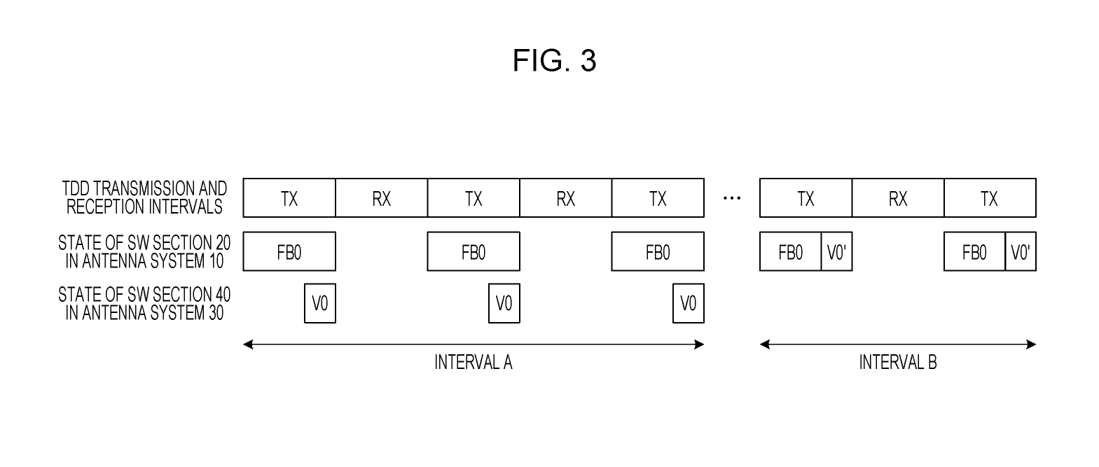

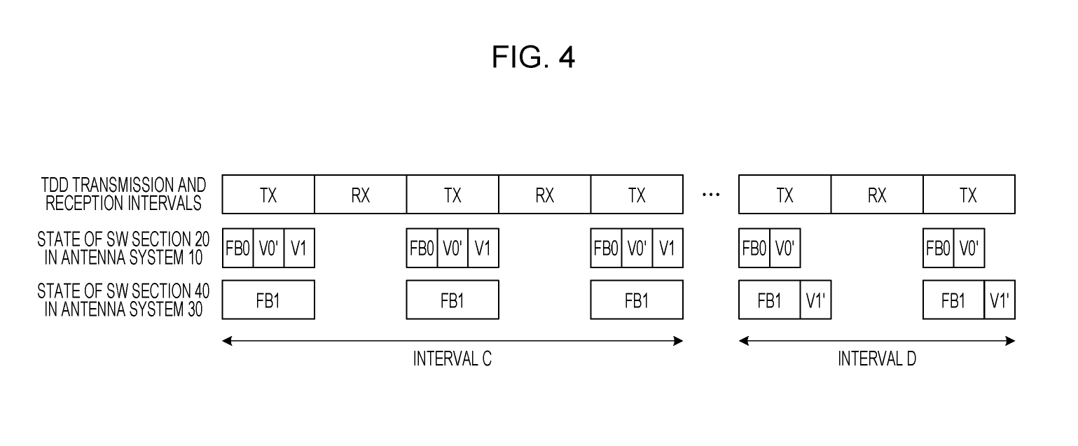

An example of processing operation by the RRH 1 will now be described by referring to FIGS. 3 and 4. FIG. 3 is a diagram (part 1) illustrating an example of the processing operation by the RRH 1. The example of FIG. 3 describes processing operation when only the antenna system 10 of the antenna systems 10 and 30 is used to transmit and receive signals. Such a case of signal transmission and reception using only the antenna system 10 of the antenna systems 10 and 30 includes a case where a transmission signal with a relatively small amount of data such as system information is transmitted to an external apparatus, for example.

In the time-division duplex system, for example, transmit intervals and receive intervals are clearly divided. As illustrated in the uppermost row of FIG. 3, the sections are switched in the order of a transmit interval (“TX” in the example of FIG. 3), a receive interval (“RX” in the example of FIG. 3), a transmit interval, a receive interval, and so on.

Upon start of the first transmit interval, the SW controller 53 sends to the SW section 20 in the antenna system 10 a selection command instructing to select a feedback signal FB0 of a transmission signal, as illustrated in the second uppermost row of FIG. 3. The SW 20a and the SW 20b in the SW section 20 receive the selection command to select the feedback signal FB0, and then output the selected feedback signal FB0 to the distortion compensator 51a in the transmission signal processor 51 via the common path. This allows the distortion compensator 51a to compensate the distortion of the transmission signal using the feedback signal FB0 relevant to the antenna system 10.

Focusing here on the first half interval from the start of the first transmit interval to the time when transmit intervals are repeated a predetermined number of times (denoted by “interval A” in the example of FIG. 3), time interval of the feedback signal FB0 is relatively long, which results in greater difference between the feedback signal FB0 and the relevant transmission signal. Consequently, the difference between the feedback signal FB0 and the relevant transmission signal is greater than a predetermined threshold. This increases time to calculate the distortion compensation coefficient for making the difference closer to 0, thereby increasing time to compensate the distortion of the transmission signal. In this case, time to calculate the VSWR relevant to the antenna system 10 may be left insufficiently in the transmit intervals included in the interval A.

Thus, the SW controller 53 sends to the SW section 40 in the antenna system 30 a selection command instructing to select a first reflection signal V0 output by the splitter 19 in the antenna system 10 in the transmit intervals included in the interval A, as illustrated in the lowermost row of FIG. 3. The SW 40b in the SW section 40 receives the selection command to select the first reflection signal V0 output by the splitter 19 in the antenna system 10, and then outputs the selected first reflection signal V0 to the VSWR calculator 51b in the transmission signal processor 51 via the common path. This allows the VSWR calculator 51b to calculate the VSWR by using the first reflection signal V0 relevant to the antenna system 10, when the distortion compensator 51a compensates the distortion of the transmission signal using the feedback signal FB0 relevant to the antenna system 10.

Focusing next on the second half interval after the interval A (denoted by “interval B” in the example of FIG. 3), time interval of the feedback signal FB0 is relatively short, which results in smaller difference between the feedback signal FB0 and the relevant transmission signal. Consequently, the difference between the feedback signal FB0 and the relevant transmission signal is equal to or less than the predetermined threshold. This decreases time to calculate the distortion compensation coefficient for making the difference closer to 0, thereby decreasing time to compensate the distortion of the transmission signal. In this case, time to calculate the VSWR relevant to the antenna system 10 may highly possibly be left in the transmit intervals included in the interval B.

Thus, the SW controller 53 sends to the SW section 20 in the antenna system 10 a selection command instructing to select a second reflection signal V0′ output by the splitter 19 in the antenna system 10 in the transmit intervals included in the interval B, as illustrated in the second uppermost row of FIG. 3. The SW 20a and the SW 20b in the SW section 20 receive the selection command to select the second reflection signal V0′ output by the splitter 19 in the antenna system 10, and then output the selected second reflection signal V0′ to the VSWR calculator 51b in the transmission signal processor 51 via the common path. This achieves both the distortion compensation of the transmission signal and the calculation of the VSWR relevant to the antenna system 10 by using only the antenna system 10.

FIG. 4 is a diagram (part 2) illustrating an example of the processing operation by the RRH 1. The example of FIG. 4 describes processing operation when both of the antenna systems 10 and 30 are used to transmit and receive signals, after the processing operation illustrated in FIG. 3. Such a case of signal transmission and reception using both of the antenna systems 10 and 30 includes a case where a transmission signal with a relatively large amount of data is transmitted to an external apparatus by a multiple-input and multiple-output (MIMO) communication system, for example. In FIG. 4, an interval after the interval B of FIG. 3 is denoted by “interval C” and an interval after the interval C is denoted by “interval D”.

As illustrated in the second uppermost row of FIG. 4, the SW controller 53 sends to the SW section 20 in the antenna system 10 a selection command instructing to select the second reflection signal V0′ output by the splitter 19 in the antenna system 10 in the transmit intervals included in the interval C. The SW 20a and the SW 20b in the SW section 20 receive the selection command to select the second reflection signal V0′ output by the splitter 19 in the antenna system 10, and then output the selected second reflection signal V0′ to the VSWR calculator 51b in the transmission signal processor 51 via the common path. This achieves both the distortion compensation of the transmission signal and the calculation of the VSWR relevant to the antenna system 10 by using only the antenna system 10.

The SW controller 53 sends to the SW section 40 in the antenna system 30 a selection command instructing to select a feedback signal FB1 of the transmission signal in the transmit intervals included in the interval C, as illustrated in the third uppermost row of FIG. 4. The SW 40a and the SW 40b in the SW section 40 receive the selection command to select the feedback signal FB1, and then output the selected feedback signal FB1 to the distortion compensator 51a in the transmission signal processor 51 via the common path. This allows the distortion compensator 51a to compensate the distortion of the transmission signal using the feedback signal FB1 relevant to the antenna system 30.

Focusing here on the interval C, time interval of the feedback signal FB1 is relatively long, which results in greater difference between the feedback signal FB1 and the relevant transmission signal. Consequently, the difference between the feedback signal FB1 and the relevant transmission signal is greater than the predetermined threshold. This increases time to calculate the distortion compensation coefficient for making the difference closer to 0, thereby increasing time to compensate the distortion of the transmission signal. In this case, time to calculate the VSWR relevant to the antenna system 30 may be left insufficiently in the transmit intervals included in the interval C.

Thus, the SW controller 53 sends to the SW section 20 in the antenna system 10 a selection command instructing to select a first reflection signal V1 output by the splitter 39 in the antenna system 30 in the transmit intervals included in the interval C, as illustrated in the second uppermost row of FIG. 4. The SW 20b in the SW section 20 receives the selection command to select the first reflection signal V1 output by the splitter 39 in the antenna system 30, and then outputs the selected first reflection signal V1 to the VSWR calculator 51b in the transmission signal processor 51 via the common path. This allows the VSWR calculator 51b to calculate the VSWR by using the first reflection signal V1 relevant to the antenna system 30, when the distortion compensator 51a compensates the distortion of the transmission signal using the feedback signal FB1 relevant to the antenna system 30.

Focusing next on the interval after the interval C (denoted by “interval D” in the example of FIG. 4), time interval of the feedback signal FB1 is relatively short, which results in smaller difference between the feedback signal FB1 and the relevant transmission signal. Consequently, the difference between the feedback signal FB1 and the relevant transmission signal is equal to or less than the predetermined threshold. This decreases time to calculate the distortion compensation coefficient for making the difference closer to 0, thereby decreasing time to compensate the distortion of the transmission signal. In this case, time to calculate the VSWR relevant to the antenna system 30 may highly possibly be left in the transmit intervals included in the interval D.

Thus, the SW controller 53 sends to the SW section 40 in the antenna system 30 a selection command instructing to select a second reflection signal V1′ output by the splitter 39 in the antenna system 30 in the transmit intervals included in the interval D, as illustrated in the lowermost row of FIG. 4. The SW 40a and the SW 40b in the SW section 40 receive the selection command to select the second reflection signal V1′ output by the splitter 39 in the antenna system 30, and then output the selected second reflection signal V1′ to the VSWR calculator 51b in the transmission signal processor 51 via the common path. This achieves both the distortion compensation of the transmission signal and the calculation of the VSWR relevant to the antenna system 30 by using only the antenna system 30.

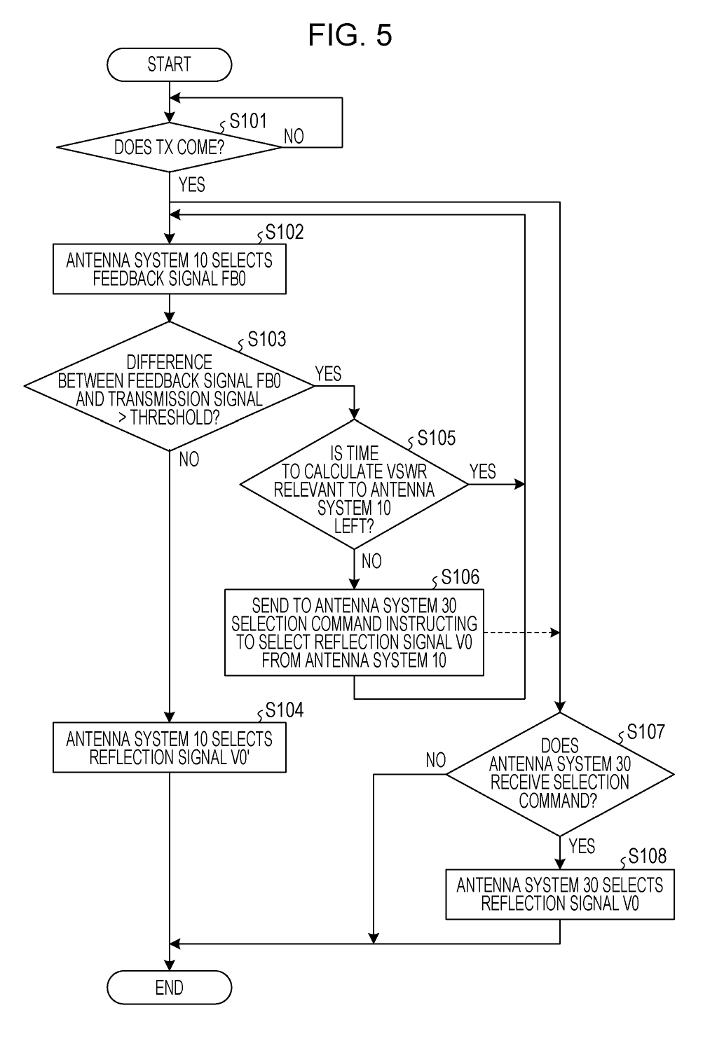

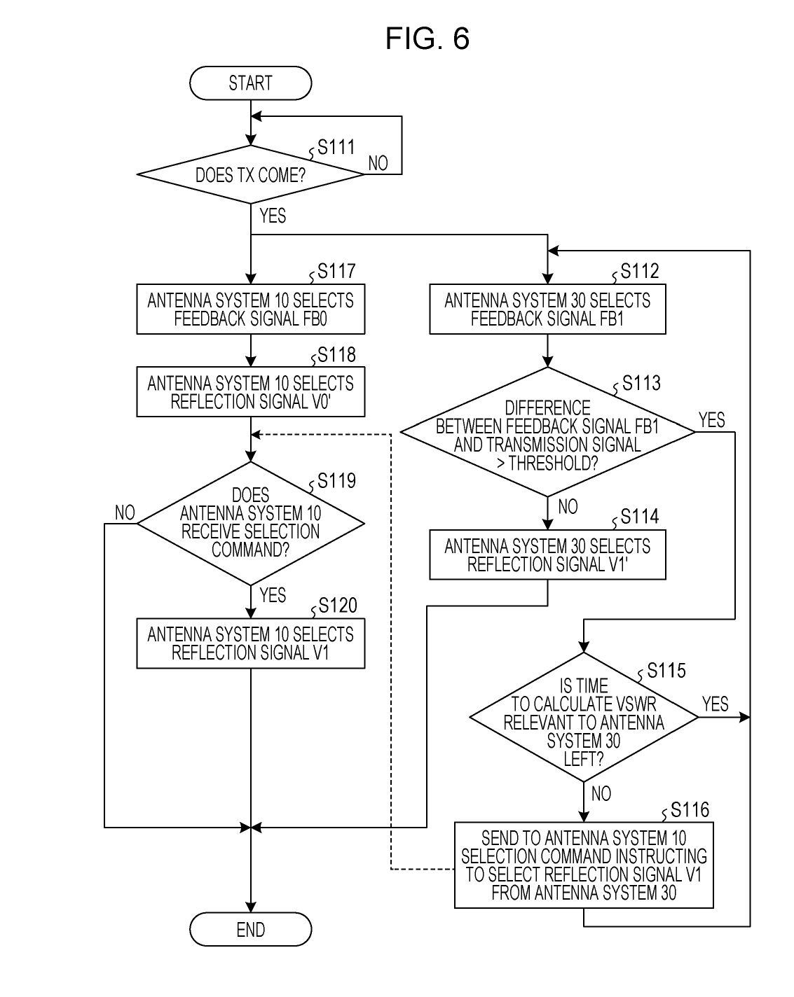

Selection processing of the signals in the RRH 1 will now be described by referring to FIGS. 5 and 6. FIG. 5 is a flowchart (part 1) illustrating the flow of the selection processing of signals in the RRH 1. The selection processing of signals illustrated in FIG. 5 correspond to the processing operation illustrated in FIG. 3.

As illustrated in FIG. 5, the transmit interval comes (YES in S101), and then the SW controller 53 sends to the SW section 20 in the antenna system 10 the selection command instructing to select the feedback signal FB0 of the transmission signal. The SW 20a and the SW 20b in the SW section 20 receive the selection command to select the feedback signal FB0, and then output the selected feedback signal FB0 to the distortion compensator 51a in the transmission signal processor 51 via the common path (S102). This allows the distortion compensator 51a to compensate the distortion of the transmission signal using the feedback signal FB0 relevant to the antenna system 10.

The SW controller 53 receives from the distortion compensator 51a information indicating the difference used for calculation of the distortion compensation coefficient, between the feedback signal FB0 and the relevant transmission signal. If the difference is equal to or less than the predetermined threshold (NO in S103), the SW controller 53 sends to the SW 20a and the SW 20b in the SW section 20 the selection command instructing to select the second reflection signal V0′ output by the splitter 19 in the antenna system 10. The SW 20a and the SW 20b in the SW section 20 receive the selection command to select the second reflection signal V0′ output by the splitter 19 in the antenna system 10, and then output the second reflection signal V0′ to the VSWR calculator 51b in the transmission signal processor 51 via the common path (S104). This achieves both the distortion compensation of the transmission signal and the calculation of the VSWR by using only the antenna system 10.

On the other hand, if the difference is greater than the predetermined threshold (YES in S103), the SW controller 53 determines whether time to calculate the VSWR relevant to the antenna system 10 is left (S105). If the time to calculate the VSWR relevant to the antenna system 10 is left (YES in S105), the SW controller 53 returns the process to S102 and continues selecting the feedback signal FB0.

If the time to calculate the VSWR relevant to the antenna system 10 is not left (NO in S105), the SW controller 53 performs the following process. The SW controller 53 sends to the SW section 40 in the antenna system 30 the selection command instructing to select the first reflection signal V0 output by the splitter 19 in the antenna system 10 (S106), returns the process to S102, and continues selecting the feedback signal FB0.

If the SW section 40 in the antenna system 30 does not receive the selection command from the SW controller 53 (NO in S107), the process ends. The SW 40b in the SW section 40 receives the selection command (YES in S107) to select the first reflection signal V0 output by the splitter 19 in the antenna system 10, and then outputs the first reflection signal V0 to the VSWR calculator 51b in the transmission signal processor 51 via the common path (S108). This allows the VSWR calculator 51b to calculate the VSWR by using the first reflection signal V0 relevant to the antenna system 10, when the distortion compensator 51a compensates the distortion of the transmission signal using the feedback signal FB0 relevant to the antenna system 10.

FIG. 6 is a flowchart (part 2) illustrating the flow of the selection processing of signals in the RRH 1. The selection processing of signals illustrated in FIG. 6 correspond to the processing operation illustrated in FIG. 4.

As illustrated in FIG. 6, the transmit interval comes (YES in S111), and then the SW controller 53 sends to the SW section 40 in the antenna system 30 the selection command instructing to select the feedback signal FB1 of the transmission signal. The SW 40a and the SW 40b in the SW section 40 receive the selection command to select the feedback signal FB1, and then output the selected feedback signal FB1 to the distortion compensator 51a in the transmission signal processor 51 via the common path (S112). This allows the distortion compensator 51a to compensate the distortion of the transmission signal using the feedback signal FB1 relevant to the antenna system 30.

The SW controller 53 receives from the distortion compensator 51a information indicating the difference used for calculation of the distortion compensation coefficient, between the feedback signal FB1 and the relevant transmission signal. If the difference is equal to or less than the predetermined threshold (NO in S113), the SW controller 53 sends to the SW section 40 in the antenna system 30 the selection command instructing to select the second reflection signal V1′ output by the splitter 39 in the antenna system 30. The SW 40a and the SW 40b in the SW section 40 receive the selection command to select the second reflection signal V1′ output by the splitter 39 in the antenna system 30, and then output the second reflection signal V1′ to the VSWR calculator 51b in the transmission signal processor 51 via the common path (S114). This achieves both the distortion compensation of the transmission signal and the calculation of the VSWR relevant to the antenna system 30 by using only the antenna system 30.

On the other hand, if the difference is greater than the predetermined threshold (YES in S113), the SW controller 53 determines whether time to calculate the VSWR relevant to the antenna system 30 is left (S115). If the time to calculate the VSWR relevant to the antenna system 30 is left (YES in S115), the SW controller 53 returns the process to S112 and continues selecting the feedback signal FB1.

If the time to calculate the VSWR relevant to the antenna system 30 is not left (NO in S115), the SW controller 53 performs the following process. The SW controller 53 sends to the SW section 20 in the antenna system 10 the selection command instructing to select the first reflection signal V1 output by the splitter 39 in the antenna system 30 (S116), returns the process to S112, and continues selecting the feedback signal FB1.

Moreover, the transmit interval comes (YES in S111), and then the SW controller 53 sends to the SW section 20 in the antenna system 10 the selection command instructing to select the feedback signal FB0 of the transmission signal. The SW 20a and the SW 20b in the SW section 20 receive the selection command to select the feedback signal FB0, and then output the selected feedback signal FB0 to the distortion compensator 51a in the transmission signal processor 51 via the common path (S117). This allows the distortion compensator 51a to compensate the distortion of the transmission signal using the feedback signal FB0 relevant to the antenna system 10.

Here, the difference used for calculation of the distortion compensation coefficient, between the feedback signal FB0 and the relevant transmission signal is equal to or less than the predetermined threshold so that the SW controller 53 performs the following process. The SW controller 53 sends to the SW section 20 in the antenna system 10 the selection command instructing to select the second reflection signal V0′ output by the splitter 19 in the antenna system 10. The SW 20a and the SW 20b in the SW section 20 receive the selection command to select the second reflection signal V0′ output by the splitter 19 in the antenna system 10, and then output the second reflection signal V0′ to the VSWR calculator 51b in the transmission signal processor 51 via the common path (S118). This achieves both the distortion compensation of the transmission signal and the calculation of the VSWR relevant to the antenna system 10 by using only the antenna system 10.

If the SW section 20 in the antenna system 10 does not receive from the SW controller 53 the selection command instructing to select the first reflection signal V1 output by the splitter 39 in the antenna system 30 (NO in S119), the process ends. The SW 20b in the SW section 20 receives the selection command (YES in S119) to select the first reflection signal V1 output by the splitter 39 in the antenna system 30, and then outputs the first reflection signal V1 to the VSWR calculator 51b in the transmission signal processor 51 via the common path (S120). This allows the VSWR calculator 51b to calculate the VSWR by using the first reflection signal V1 relevant to the antenna system 30, when the distortion compensator 51a compensates the distortion of the transmission signal using the feedback signal FB1 relevant to the antenna system 30.

As described above, the RRH 1 in the present embodiment enables the calculation of the VSWR relevant to one of the antenna systems 10 and 30 by controlling the SW section in the other antenna system when the distortion is compensated using the feedback signal selected by the one antenna system. This achieves both the distortion compensation and the VSWR calculation.

In the RRH 1 in the present embodiment, for example, when the difference between the feedback signal selected by one of the antenna systems and the relevant transmission signal is greater than the predetermined threshold, the SW section in the other antenna system is controlled and the VSWR relevant to the one antenna system is calculated. This enables the VSWR calculation relevant to the one antenna system using the other antenna system even when longer time is taken to calculate the distortion compensation coefficient for making the difference closer to 0. As a result, according to the RRH 1 of the present embodiment, degradation of the distortion compensation characteristics may be suppressed and the accuracy of the VSWR calculation may be maintained.

### Embodiment 2

Embodiment 2 is different from embodiment 1 in that the SW section in each antenna system receives a reception signal. The following mainly describes a case where the SW section in each antenna system selects a reception signal.

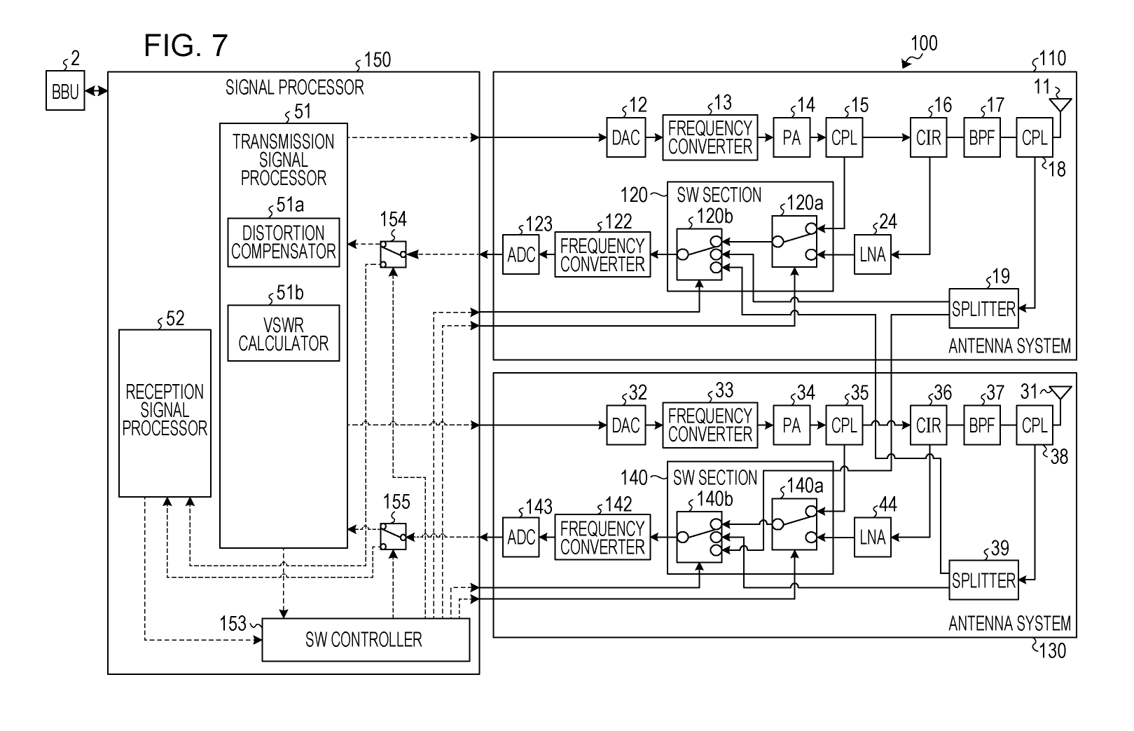

FIG. 7 is a block diagram illustrating details of an RRH 100 in embodiment 2. In embodiment 2, sections and components with the same reference characters in embodiment 1 are intended to have the same functions as those in embodiment 1 unless otherwise specified.

An RRH 100 includes antenna systems 110 and 130 and a signal processor 150, as illustrated in FIG. 7. The signal processor 150 includes a SW controller 153 instead of the SW controller 53 in FIG. 2 and additionally includes a SW 154 and a SW 155.

The antenna system 110 includes a SW section 120 instead of the SW section 20 in FIG. 2, a frequency converter 122 instead of the frequency converter 22 and the frequency converter 25 in FIG. 2, and an ADC 123 instead of the ADC 23 and the ADC 26 in FIG. 2. Moreover, the antenna system 110 does not include the ATT 21 in FIG. 2.

The SW section 120 selects a second reflection signal, a first reflection signal output by the splitter 39 in the antenna system 130, a feedback signal of a transmission signal, or a reception signal to output the selected signal via a common path. Specifically, the SW section 120 includes a SW 120a and a SW 120b.

The SW 120a receives the feedback signal input from the CPL 15 and receives the reception signal input from the LNA 24. The SW 120a then selects the feedback signal or the reception signal to output the selected feedback signal or reception signal to the SW 120b.

The SW 120b receives the feedback signal or the reception signal input from the SW 120a, receives the second reflection signal input from the splitter 19, and receives from the splitter 39 in the antenna system 130 the first reflection signal output by the splitter 39 in the antenna system 130. The SW 120b selects the second reflection signal, the first reflection signal output by the splitter 39 in the antenna system 130, the feedback signal, or the reception signal to output the selected signal to the frequency converter 122. The signal output from the SW 120b to the frequency converter 122 is output from the antenna system 110 via the frequency converter 122 and the ADC 123 to be input to the SW 154 in the signal processor 150.

As described above, the SW section 120 uses the SW 120a and the SW 120b to select the second reflection signal, the first reflection signal output by the splitter 39 in the antenna system 130, the feedback signal, or the reception signal. The SW section 120 then outputs the selected signal to the SW 154 in the signal processor 150 via the frequency converter 122 and the ADC 123 that serve as the common path. Using the frequency converter 122 and the ADC 123 as the common path consequently reduces the circuit size of the antenna system 110.

The selection of signals in the SW section 120 is controlled by the later-described SW controller 153. The SW section 120 is an example of the selection section.

The frequency converter 122 receives the second reflection signal, the first reflection signal output by the splitter 39 in the antenna system 130, the feedback signal of the transmission signal, or the reception signal that is selected and input by the SW section 120. The frequency converter 122 then performs frequency conversion on the second reflection signal, the first reflection signal output by the splitter 39 in the antenna system 130, the feedback signal of the transmission signal, or the reception signal and converts the signal into a baseband signal to output the signal converted into the baseband signal to the ADC 123.

The ADC 123 receives the second reflection signal, the first reflection signal output by the splitter 39 in the antenna system 130, the feedback signal of the transmission signal, or the reception signal that is input from the frequency converter 122. The ADC 123 then converts the second reflection signal, the first reflection signal output by the splitter 39 in the antenna system 130, the feedback signal of the transmission signal, or the reception signal into a digital signal to output the signal converted into the digital signal to the SW 154 in the signal processor 150.

The antenna system 130 includes a SW section 140 instead of the SW section 40 in FIG. 2, a frequency converter 142 instead of the frequency converter 42 and the frequency converter 45 in FIG. 2, and an ADC 143 instead of the ADC 43 and the ADC 46 in FIG. 2. Moreover, the antenna system 130 does not include the ATT 41 in FIG. 2.

The SW section 140 selects a second reflection signal, a first reflection signal output by the splitter 19 in the antenna system 110, a feedback signal of a transmission signal, or a reception signal to output the selected signal via a common path. Specifically, the SW section 140 includes a SW 140a and a SW 140b.

The SW 140a receives the feedback signal input from the CPL 35 and receives the reception signal input from the LNA 44. The SW 140a then selects the feedback signal or the reception signal to output the selected feedback signal or reception signal to the SW 140b.

The SW 140b receives the feedback signal or the reception signal input from the SW 140a, receives the second reflection signal input from the splitter 39, and receives, as an input from the splitter 19 in the antenna system 110, the first reflection signal output by the splitter 19 in the antenna system 110. The SW 140b selects the second reflection signal, the first reflection signal output by the splitter 19 in the antenna system 110, the feedback signal, or the reception signal to output the selected signal to the frequency converter 142. The signal output from the SW 140b to the frequency converter 142 is output from the antenna system 130 via the frequency converter 142 and the ADC 143 to be input to the SW 155 in the signal processor 150.

As described above, the SW section 140 uses the SW 140a and the SW 140b to select the second reflection signal, the first reflection signal output by the splitter 19 in the antenna system 110, the feedback signal, or the reception signal. The SW section 140 then outputs the selected signal to the SW 155 in the signal processor 150 via the frequency converter 142 and the ADC 143 that serve as the common path. Using the frequency converter 142 and the ADC 143 as the common path consequently reduces the circuit size of the antenna system 130.

The selection of signals in the SW section 140 is controlled by the later-described SW controller 153. The SW section 140 is an example of the selection section.

The frequency converter 142 receives the second reflection signal, the first reflection signal output by the splitter 19 in the antenna system 110, the feedback signal of the transmission signal, or the reception signal that is selected and input by the SW section 140. The frequency converter 142 then performs frequency conversion on the second reflection signal, the first reflection signal output by the splitter 19 in the antenna system 110, the feedback signal of the transmission signal, or the reception signal and converts the signal into a baseband signal to output the signal converted into the baseband signal to the ADC 143.

The ADC 143 receives the second reflection signal, the first reflection signal output by the splitter 19 in the antenna system 110, the feedback signal of the transmission signal, or the reception signal that is input from the frequency converter 142. The ADC 143 then converts the second reflection signal, the first reflection signal output by the splitter 19 in the antenna system 110, the feedback signal of the transmission signal, or the reception signal into a digital signal to output the signal converted into the digital signal to the SW 155 in the signal processor 150.

The SW 154 outputs the signal from the ADC 123 selectively to the transmission signal processor 51 or the reception signal processor 52 based on the control by the SW controller 153.

The SW 155 outputs the signal from the ADC 143 selectively to the transmission signal processor 51 or the reception signal processor 52 based on the control by the SW controller 153.

The SW controller 153 has basically the same function as that of the SW controller 53 in FIG. 2. Additionally, the SW controller 153 causes the reception signal selected by the SW section in each antenna system (the SW section 120 or the SW section 140) to be input to the reception signal processor 52. The SW controller 153, for example, controls the SW 154 to cause the reception signal from the ADC 123 to be input to the reception signal processor 52, and controls the SW 155 to cause the reception signal from the ADC 143 to be input to the reception signal processor 52, in receive intervals in the time-division duplex system.

Moreover, the SW controller 153 causes a signal other than the reception signal selected by the SW section in each antenna system (the SW section 120 or the SW section 140) to be input to the transmission signal processor 51. The SW controller 153, for example, controls the SW 154 to cause the second reflection signal, the first reflection signal output by the splitter 39 in the antenna system 130, or the feedback signal of the transmission signal to be input to the transmission signal processor 51 in transmit intervals in the time-division duplex system. The SW controller 153, as another example, controls the SW 155 to cause the second reflection signal, the first reflection signal output by the splitter 19 in the antenna system 110, or the feedback signal of the transmission signal to be input to the transmission signal processor 51 in transmit intervals in the time-division duplex system.

As described above, the RRH 100 in the present embodiment enables the SW section in each antenna system to select the second reflection signal, the first reflection signal output by the splitter in the other antenna system, the feedback signal of the transmission signal, or the reception signal to output the selected signal via the common path. The RRH 100 in the present embodiment also causes the reception signal selected by the SW section in each antenna system to be input to the reception signal processor. This allows the reflection signal, the feedback signal of the transmission signal, or the reception signal to be output by using a single path, enabling the reduction in the circuit size of the entire RRH.

The aforementioned description provides an example of the RRH having two antenna systems (the antenna systems 10, 30 or the antenna systems 110, 130). However, the number of antenna systems is not limited to two but three or more antenna systems may be applicable.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless apparatus, comprising:
a plurality of antenna systems each configured to include:
an antenna,
a splitter configured to split a reflection signal obtained by reflecting a transmission signal from the antenna into a first reflection signal and a second reflection signal and output the first reflection signal to another antenna system, and
a selection section configured to select the second reflection signal, the first reflection signal output by the splitter in the another antenna system, or a feedback signal of the transmission signal and output the selected signal via a common path;
a distortion compensator configured to compensate distortion of the transmission signal by using the feedback signal selected by the selection section in the antenna system;
a standing wave ratio calculator configured to calculate a standing wave ratio by using the first reflection signal or the second reflection signal that is selected by the selection section in the antenna system; and
a controller configured to, when the distortion of the transmission signal is compensated by using the feedback signal selected by the selection section in one of the plurality of antenna systems, control the selection section in the another antenna system so as to calculate the standing wave ratio by using the first reflection signal output by the splitter in the one antenna system.

2. The wireless apparatus according to claim 1,
wherein the distortion compensator is configured to calculate a distortion compensation coefficient for making a difference between the feedback signal selected by the selection section in each of the antenna systems and the relevant transmission signal closer to 0 and to compensate the distortion of the transmission signal by using the calculated distortion compensation coefficient, and
the controller is configured to, when the difference between the feedback signal selected by the selection section in the one antenna system and the relevant transmission signal is greater than a predetermined threshold, control the selection section in the another antenna system.

3. The wireless apparatus according to claim 2, wherein the controller is configured to control the selection section in the one antenna system so as to stop control of the selection section in the another antenna system when the difference is equal to or less than the predetermined threshold and to calculate the standing wave ratio by using the second reflection signal after the distortion compensation of the transmission signal is finished.

4. The wireless apparatus according to claim 1,
wherein the selection section in each of the antenna systems is configured to select the second reflection signal, the first reflection signal output by the splitter in the another antenna system, the feedback signal of the transmission signal, or a reception signal and to output the selected signal via the common path, and
the controller is configured to cause the reception signal selected by the selection section in each of the antenna systems to be input to a reception signal processor that performs predetermined reception processing.

5. The wireless apparatus according to claim 1,
wherein the wireless apparatus is a wireless apparatus to which a time-division duplex system is applied, and
the controller is configured to control the selection section in the another antenna system when the distortion of the transmission signal is compensated, in a transmit interval in the time-division duplex system.
